(19) United States
(12) Patent Application Publication
(10) Pub. No.: US 2026/0236384 A1
(43) Pub. Date: Aug. 13, 2026

(54) DEVICE AND METHOD FOR REMOTELY ACCESSING AT LEAST ONE TEST ENVIRONMENT BY MEANS OF AT LEAST ONE USER APPLICATION

(71) Applicant: dSPACE GmbH, Paderborn (DE)

(72) Inventors: Hendirk AMSBECK, Paderborn (DE); Thomas KOLLMEIER, Paderborn (DE); Dirk STICHLING, Paderborn (DE); Alexander GÖTZ, Paderborn (DE); Franklin Lee HUBBELL, Paderborn (DE); Niklas JUNGE, Paderborn (DE); Thomas TRILLING, Paderborn (DE); Rafael SPYRA, Paderborn (DE)

(21) Appl. No.: 19/156,420

(22) PCT Filed: Dec. 14, 2023
(86) PCT No.: PCT/EP2023/085746

§ 371 Date: Oct. 14, 2025

(30) Foreign Application Priority Data
Feb. 16, 2023 (DE) 10 2023 103 766.8

(51) Int. Cl. G06F 11/3698; G06F 11/22; G06F 11/30; H04L 9/40

(52) U.S. Cl. CPC G06F 11/3698; G06F 11/2294; G06F 11/302; H04L 63/08

(57) ABSTRACT

A device for remotely accessing at least one test environment via at least one user application is configured to: make a first login interface available to the at least one user application for logging in via the communication network; and make a second login interface available to the at least one test environment for logging in. The device is further configured to: transmit display data to the at least one user application; receive control data for the at least one test environment from the at least one user application; transmit the control data to the at least one test environment via the measuring interface; and receive measurement data for generating the display data from the at least one test environment. Remote access to the at least one test environment is enabled for the at least one user application.

### CROSS-REFERENCE TO PRIOR APPLICATIONS

This application is a U.S. National Phase application under 35 U.S.C. § 371 of International Application No. PCT/EP2023/085746, filed on Dec. 14, 2023, and claims benefit to German Patent Application No. DE 102023103766.8, filed on Feb. 16, 2023. The International Application was published in German on Aug. 22, 2024 as WO 2024/170132 A1 under PCT Article 21(2).

### TECHNICAL FIELD

The application relates to a device and to a method for remote access to at least one test environment by at least one user application.

### BACKGROUND

Test environments are used, for example, in the development of control units, such as those used for example in the automotive industry or in the aerospace industry for controlling technical systems, for example motors/engines or brakes. The development of control units has become a highly complex process. For instance, new open- and closed-loop control functions for control units should be tested as early as possible in the development process in order to verify functionality and define the direction of further development. At more advanced stages of the development process, it is important to test the already well-developed control unit as comprehensively as possible.

Test environments can offer the possibility of testing such a system to be tested via an environment model. A system to be tested may include both functions, for example software, and equipment, for example hardware, that can be tested in the test environment. The environment model simulates the relevant environment by suitable data exchange for the software or the hardware. The test environments may have an interface to a user who can carry out experiments with the system to be tested via the test environments. Experiments can be used to set parameters for the simulations with the system to be tested and the environment model, and values arising in the simulation can be displayed and recorded.

### SUMMARY

In an exemplary embodiment, the present invention provides a device for remotely accessing at least one test environment via at least one user application. The device provides a computer resource available via a communication network. The computer resource comprises an experiment manager and at least one measuring entity. The device comprises: at least one processor; and a memory having processor-executable instructions stored thereon. The at least one processor is configured to execute the processor-executable instructions to facilitate performance of the following by the device: making, by the experiment manager, a first login interface available to the at least one user application for logging in via the communication network; and making, by the experiment manager, a second login interface available to the at least one test environment for logging in, wherein the second login interface provides a login via a software agent. The at least one measuring entity has a monitoring interface for the at least one user application and a measuring interface for the at least one test environment. The at least one processor is further configured to execute the processor-executable instructions to facilitate performance of the following by the device: transmitting display data to the at least one user application via the monitoring interface; receiving control data for the at least one test environment from the at least one user application; transmitting the control data to the at least one test environment via the measuring interface; and receiving measurement data for generating the display data from the at least one test environment. Remote access to the at least one test environment is enabled for the at least one user application.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic representation of a system;

FIG. 2 is a further schematic representation of the system of FIG. 1; and

FIG. 3 is a flowchart of a method.

In the drawings, the same reference signs are used for the same or similar elements. The depictions in the drawings may not be to scale.

### DETAILED DESCRIPTION

A device for remote access to at least one test environment by at least one user application takes the form of a computer resource available via a communication network. The computer resource has an experiment manager and at least one measuring entity.

The experiment manager makes a first login interface available to the at least one user application for logging in via the communication network. The experiment manager makes a second login interface available to the at least one test environment for logging in, in particular via the communication network. The second login interface for logging in the at least one test environment provides the login via a software agent.

The at least one measuring entity has a monitoring interface for the at least one user application and a measuring interface for the at least one test environment. Provision is made for display data to be transmitted to the at least one user application via the monitoring interface and for control data for the test environment, for example for a measurement and/or simulation running in the test environment, to be received from the at least one user application. Provision is made for the control data to be transmitted to the at least one test environment via the measuring interface and for measurement data for generating the display data to be received from the at least one test environment, such that remote access to the at least one test environment is enabled for the at least one user application.

The device allows at least one user at any given location to obtain remote access to at least one test environment via the device via a communication network and via a computer resource thus available. This results in greater flexibility as to where the users or the test environment may be located. For example, it is possible for users located in different time zones to access a test environment around the clock. This results in more efficient use of such a test environment and so saves time and money. Using the communication network, multiple users can also work simultaneously on the same test environment via the remote access. The device makes this remote access technically reliable and easy to implement.

Since the test environment logs itself in to the computer resource and in particular to the experiment manager via a software agent, no human action is required from the test environment to enable remote access. Using the computer resource for remote access to the test environment or a plurality of test environments makes it possible for different users to simultaneously access the same test environment or different test environments. By using the computer resource, it is furthermore possible for each test environment to be globally available for remote access.

According to the application, remote access is taken to mean that a user application that is present at a first location can access a test environment that is present at a second location. This makes it possible in particular to overcome large distances, such as several 100 km or several 1000 km, between the first and second locations, thereby also enabling, for example, global access spread around the world.

The at least one test environment provides the capability, via software or hardware, to verify the functionality of a system to be tested (system under test) and carry out measurements with it. What are known as hardware-in-the-loop (HIL) or software-in-the-loop (SIL) simulators can be used for this purpose, for example. Using a hardware-in-the-loop simulator, it is possible to test, for example, equipment to be tested, for example control units, used in a vehicle for controlling a system, for example a motor/engine, with regard to many possible situations. Using a software-in-the-loop simulator, it is possible to test software, for example functions in the form of software code, for example in interaction with a simulated environment. In the case of a vehicle, this saves on test drives, for example. In particular when electronics and software are used, such a test environment enables the testing of a plurality of situations that may occur later during use. Since companies that use such test environments have users in different countries, such remote access according to the present application is of particular advantage in order to permit access to the test environment irrespective of the location of the user, it being possible to set up and operate the test environment at another location.

The user application is provided to allow the user making use of the test environment as an operator to access the test environment. The user application may, for example, have a graphical user interface to allow the user to interact with it. The user application may, for example, be browser-based software by which measurement data from the test environment can be graphically displayed and further analyzed, the user application generating control data in accordance with user input that influence the simulation and/or measurement on the test environment. Instead of browser-based software, other implementations of the user application are also possible, for example by way of an app.

The communication network may, for example, be the internet but also, for example, alternatively or additionally a corporate global communication network.

In the present case, the computer resource may be taken to be what is known as a cloud solution that is maintained, for example, by the company that itself makes use of the test environment and the user application, or indeed by a service provider that hosts the computer resource.

The computer resource has an experiment manager, for example in the form of a software module, that makes a first login interface for the user application available for logging in via the communication network. The experiment manager furthermore has a second login interface for the test environment so that, as described, the test environment can log itself in via a software agent. Software and communication technologies that are commonly used, for example on the internet, are used for the login interfaces.

A software agent is taken to mean a computer program that behaves independently and dynamically within a specified framework. This means that, depending on various states, a certain processing procedure runs without any further external start signal, or any external control intervention during the procedure. In the present case, this allows the test environment to log itself in to the experiment manager via the second login interface. When the test environment is set in operation accordingly, this test environment can then immediately log itself in to the experiment manager via the software agent, thus making itself available to the user applications for remote access. It is possible for different test environments to log themselves in to the experiment manager in order to be available for remote access. Accordingly, numerous users can log in to the experiment manager via their user application, although this is initiated by the user themselves while the relevant software agent ensures automatic login to the experiment manager for the particular test environment. The first login interface, like the second login interface, is accordingly a software module of the experiment manager.

The computer resource furthermore has a measuring entity that can likewise take the form of a software module. The measuring entity has a monitoring interface for the at least one user application and a measuring interface for the at least one test environment. The monitoring interface supplies display data to the at least one user application, while the user application transmits control data for the test environment, for example for a measurement and/or simulation, via the monitoring interface to the measuring entity. The measuring interface ensures that the control data are transmitted to the at least one test environment and measurement data for generating the display data are received from the at least one test environment. Remote access from the user application to the test environment is thus enabled via the computer resource. In particular, transmission of the above-mentioned data can in the present case be packet-oriented, i.e., there need not be a complete or continuous communication channel from the user application to the test environment, thus facilitating remote access from a plurality of user applications to a test environment or also to different test environments.

In connection with the login of the test environment, provision is made for information about the test environment to be transmitted to the experiment manager as configuration data. The experiment manager is thus aware of what can be tested via the test environment and how, and also, for example, what kind of simulator the test environment has.

Furthermore, it is provided that the at least one measuring entity is set up to process the measurement data for generating the display data on the basis of display configuration data. The measurement data for generating the display data are thus processed by the user applications in accordance with requirements. Access to the measuring entity may be established, for example, via the experiment manager. A measuring entity can be set up to communicate with a plurality of user applications and/or a plurality of test environments and in particular to process their data.

Moreover, it is provided that the at least one measuring entity is set up to process the control data on the basis of the configuration data prior to transmission to the at least one test environment. The control data can thus be adapted to the configuration of the test environment. The test environment can thus put these processed control data to immediate use during testing and/or in the simulation and/or in the measurement. In particular, the measuring entity can communicate with a plurality of test environments and process and transmit the control data using the configuration data adapted to the particular test environment.

Furthermore, it is provided that the computer resource has a database that is provided for storing information about the logins, the control data, the measurement data, the configuration data, and/or the display configuration data, the storage in particular being provided by the experiment manager. This storage makes it possible to keep track of processes by remote access. For example, if a communication failure occurs, remote access can be restarted with the assistance of these saved data. To save these data, the experiment manager is in particular suitable as an entity for controlling saving. Alternatively or additionally, the database can enable data exchange of data in shared use within the computer resource.

Furthermore, it is also provided that the computer resource has a post-processing service that is set up to record, manage, and provide access to the measurement data. This measure also enables re-access to such measurement data in retrospect, in particular in the case of communication failures but also to retrace things from the past.

Furthermore, it is provided that the database and/or a further repository is/are provided for storing the measurement data. The database and the further repository can also be embodied as a shared repository.

For remote access to at least one test environment by at least one user application, use being made of a computer resource that is available via a communication network and has an experiment manager and at least one measuring entity, a method having the following method steps is provided:
logging in the least one user application to the experiment manager,
logging in the at least one test environment to the experiment manager, wherein the at least one test environment uses a software agent for logging in,
wherein the at least one measuring entity has a monitoring interface for the at least one user application and a measuring interface for the at least one test environment,
wherein the at least one measuring entity transmits display data to the at least one user application and receives control data for the test environment, in particular a simulation and/or measurement running thereon, from the at least one user application, wherein the at least one measuring entity transmits the control data to the at least one test environment and receives measurement data for generating the display data from the at least one test environment,
such that remote access to the at least one test environment is enabled for the at least one user application.

The method offers the advantage whereby at least one user at any given location can obtain remote access to at least one test environment via a communication network and via a computer resource thus available. This results in greater flexibility as to where the users or the test environment may be located. Using the computer resource for remote access to the test environment or a plurality of test environments makes it possible for different users to simultaneously access the same test environment or different test environments. By using the computer resource, it is furthermore possible for each test environment to be globally available for remote access.

In one embodiment of the method, in connection with login, the test environment transmits information about the test environment to the experiment manager as configuration data. The experiment manager is thus aware of what can be tested via the test environment and how.

The at least one measuring entity can process the measurement data for generating the display data on the basis of display configuration data. The measurement data for generating the display data are thus processed by the user applications in accordance with requirements. This enables adaptation to the display options on the particular user application.

In some embodiments of the method, the at least one measuring entity can process the control data on the basis of the configuration data prior to transmission to the at least one test environment. This allows control data to be adapted to the conditions in the particular test environment. The test environment can thus put these processed control data to immediate use in testing.

In some embodiments of the method, the experiment manager can save information about the logins, the control data, the measurement data, the configuration data, and/or the display configuration data in a database.

A post-processing service that records, manages, and/or provides access to the measurement data in a method step may further be provided.

The user application has a user interface for displaying the display data and for inputting the control data. The display data are configured such that they are suitable for graphically representing the user application and also for further analysis by the user. For example, the user can use mathematical methods to further process the display data to gain additional insights. The control data instruct the test environment to measure the equipment under test, for example in specific parameter ranges. The test environment is therefore set up to communicate with the device, to test the system under test, for example an item of hardware and/or software, and to generate the measurement data, the measurement data being dependent on the system to be tested, for example the hardware and/or software.

A system that includes a device as described above, a user application as described above, and a test environment as described above is furthermore provided.

Furthermore, it is provided that the test environment has the software agent, the software agent being provided for logging in to the experiment manager. The test environment can, for example, be at a location remote from the computer resource. The test environment can also be located on the computer resource and run thereon as software, for example.

Moreover, it is provided that the test environment is provided for communicating with the device via the communication network. This is advantageous in particular for embodiments in which the test environment is at a location remote from the computer resource. This may be of advantage in particular for test environments having a hardware-in-the-loop simulator.

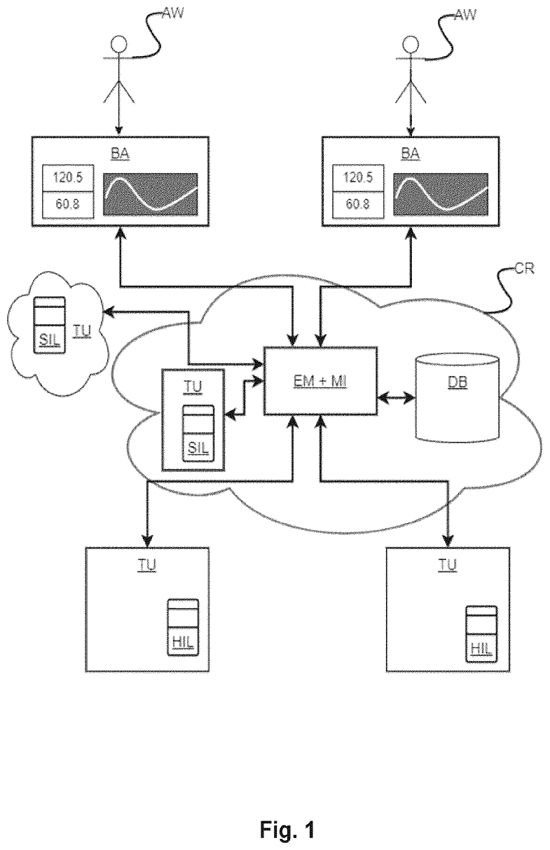

FIG. 1 schematically shows, by way of example, a system having two user applications BA, two users AW, a computer resource CR, and four test environments TU. The computer resource has an experiment manager EM and at least one measuring entity MI. The experiment manager EM and the at least one measuring entity MI enable remote access by each user application BA to each test environment TU.

FIG. 1 shows, by way of example, two users AW each with their respective user applications BA. Embodiments may also have more or fewer users AW. Two of the test environments TU each have a hardware-in-the-loop simulator HIL and are located outside the computer resource CR. Two other test environments TU each have a software-in-the-loop simulator SIL. One of the test environments TU having a software-in-the-loop simulator SIL is located outside the computer resource CR. The second of the test environments TU having a software-in-the-loop simulator SIL is located within the computer resource CR.

Test environments TU that have a plurality of hardware-in-the-loop simulators HIL or a plurality of software-in-the-loop simulators SIL may also be used. Test environments TU that have both at least one hardware-in-the-loop simulator HIL and at least one software-in-the-loop simulator SIL may also be used.

A system under test or system to be tested is in each case connected to the simulator SIL, HIL. In the case of a software-in-the-loop simulator SIL, the system to be tested may take the form of software. In the case of a hardware-in-the-loop simulator HIL, the system to be tested may take the form of hardware, for example equipment or a control unit. The system to be tested can be accessed separately from the simulator SIL, HIL via the relevant software agent SWA. In particular, measurement data can be acquired, and further data, for example configuration data, can be read out. Remote access to the system to be tested can thus be enabled via the described computer resource CR.

A parameter range of 60.8 to 120.5 is shown in the user applications BA by way of example, along with a curve in graph form that in each case originates, for example, from one of the test environments TU, i.e., measurement data from the test environment TU can be displayed in the user applications BA. The values 60.8 and 120.5 shown by way of example may also be measured values at a specific point in time. The curve may also, for example, be the time curve of a measured value.

The user applications BA communicate via a communication network, for example the internet, with the computer resource CR, which may be a cloud application, for example. The user applications BA log in to the experiment manager EM in the computer resource CR and exchange data with the experiment manager EM. These data comprise, for example, configuration data and display configuration data. The experiment manager EM may save such data in a database DB.

The experiment manager EM may be connectable to a test environment TU or plurality of test environments TU within the computer resource CR and/or connectable to a test environment or plurality of test environments TU outside the computer resource CR. At the same time, it is possible for the experiment manager to be simultaneously connected to a plurality of test environments TU, whether within the computer resource CR or outside the computer resource CR.

If the test environment TU is within the computer resource CR, it may in particular be a test environment that is configured to test software and therefore has a software-in-the-loop simulator SIL. Test environments TU outside the computer resource CR may in particular be test environments TU that have at least one software-in-the-loop simulator SIL and/or hardware-in-the-loop simulator HIL.

As shown above, the test environments TU log in to the experiment manager EM and transmit login data that relate to the identity of the test environment and configuration data that relate to the conditions of the test environment TU. The login data allow the experiment manager to establish a login authorization for the particular test environment. If this login authorization is not available, login is refused. The experiment manager EM transmits the configuration data and/or the login data to a database DB for storage.

Login to the test environments TU takes place as described above via a particular software agent SWA. The software agent SWA allows the test environment TU to log itself in to the experiment manager EM independently. Logging off, for example if the test environment TU analy zes that it is no longer operating correctly, is also possible via the software agent SWA. The software agent SWA not only logs in to the experiment manager EM for the particular test environment but also transmits the login data and configuration data for the experiment manager EM with regard to the particular test environment TU.

After logging in to the experiment manager EM, the user application BA can connect to the measuring entity MI in order thereby to exchange display and control data with the test environment TU. The measuring entity MI can be set up such that a plurality of user applications BA can each use it to exchange data simultaneously with one or more test environments TU. Each measuring entity MI can additionally exchange control data and display data with each user application BA. Each measuring entity MI can additionally exchange measurement data and control data with each test environment TU.

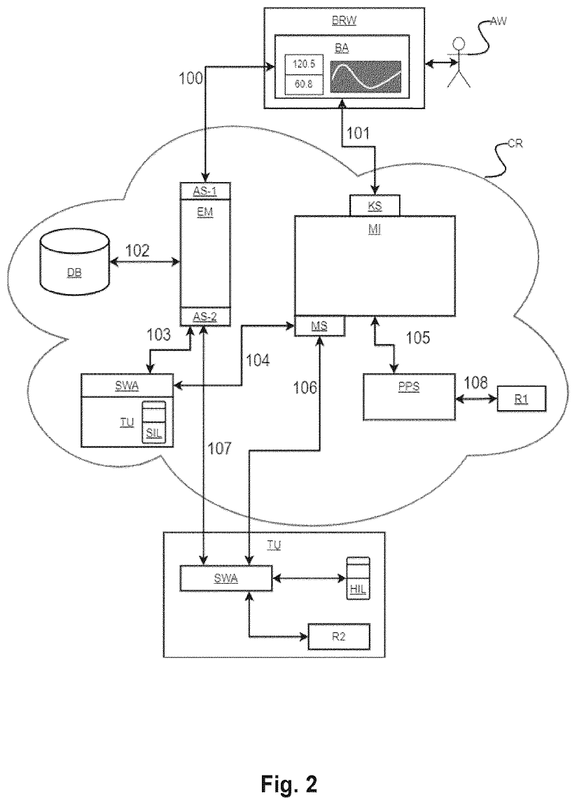

FIG. 2 schematically shows, by way of example, a further embodiment of the system having a user application BA, a user AW, the computer resource CR, and two test environments TU. FIG. 2 shows the system in greater detail than FIG. 1.

One of the test environments TU has a hardware-in-the-loop simulator HIL and is located outside the computer resource CR. In addition to the hardware-in-the-loop simulator HIL, this test environment TU includes the system to be tested, which in the present case is in hardware form. The system to be tested is connected to the hardware-in-the-loop simulator HIL for the stated testing purposes. Another test environment TU has a software-in-the-loop simulator SIL and is located within the computer resource CR. In addition to the software-in-the-loop simulator SIL, this test environment TU includes a system to be tested, which in the present case is in software form. The system to be tested is connected to the software-in-the-loop simulator SIL for the stated testing purposes.

The user AW is using their user application BA via a browser BRW. The browser BRW may, for example, be what is known as a web browser, which is an application for displaying internet pages.

Via the connection 100, the user application BA logs in to the experiment manager EM via a first login interface AS-1 with display configuration data. The display configuration data state what the user AW would like to see displayed, for example value ranges and other parameters. The experiment manager EM saves these data, like other data, in the database DB via the connection 102. The user application BA then connects to the measuring entity MI via the monitoring interface KS in order to exchange display and control data with the measuring entity MI. This takes place via the connection 101. The experiment manager EM having its login interfaces AS-1 and AS-2, and the measuring entity MI having the monitoring interface KS and also the further measuring interface MS, are all arranged in the computer resource CR, as is the database DB.

In the test environment, the SIL test environment TU uses its software agent SWA to log in to the experiment manager EM via the connection 103 via the second login interface AS-2. The HIL test environment TU uses its software agent SWA to log in to the experiment manager EM via the connection 107 via the second login interface AS-2.

During each logging in of the test environment TU, configuration data about the test environment TU are also stored in the experiment manager EM, which in turn saves the data again in the database DB via the connection 102. The test environments TU furthermore connect to the measuring entity MI via the connections 104 and 106 via the measuring interface MS. The relevant software agent SWA is also used to this end.

The computer resource CR can in particular be configured such that the experiment manager EM, the measuring entity MI, and/or the post-processing service PPS can save data in the database DB and also read them out again. In particular, configuration data can be saved in the database DB and read out again. The database DB can thus also be the storage location for data in shared use, in particular within the computer resource. The data in shared use can thus be exchanged via the database DB.

To enable the test environment TU to access the measuring entity MI, the test environment TU logs itself in to the experiment manager EM via the relevant software agent SWA, as described above. The experiment manager can be reached, for example, via a fixed address known to the test environment TU. The software agent SWA of the test environment TU is informed by the experiment manager EM of the address of the measuring entity MI, via which it carries out further communication. The user application BA accesses the measuring entity MI in a similar manner. The user application BA is informed by the experiment manager EM of the address of the measuring entity MI. Communication, in particular the exchange of measurement data, between the user application BA and the test environment TU can then take place via the measuring entity MI. A measuring entity MI can communicate with a plurality of test environments TU. In the event of a high level of utilization, further measuring entities MI can be launched. This launch in the event of a high level of utilization can be carried out, for example, by a higher-level monitoring entity of the computer resource CR. New user applications BA and test environments TU that log in can then be assigned the further, newly launched measuring entities MI.

The connection 106 between the HIL test environment TU and the measuring entity MI is used to exchange control data and measurement data, the control data being supplied by the measuring entity MI and the measurement data by the test environment TU. Control data are originally supplied by the user application BA via the connection 101 to the measuring entity MI, optionally processed thereby, and transmitted to the HIL test environment TU via the connection 106.

The HIL test environment TU outside the computer resource CR also has an optional repository R2, in which the software agent SWA of the test environment TU can save measurement data. In this way, measurement data can be stored locally, which can be advantageous in particular if such data arise at a very high data throughput. This is useful in particular if the connection 106, which may after all be global via a communication network, is not fast enough in terms of latency (delay) and data throughput (volume of data per unit time) to accept the measurement data arising in the test environment TU. In a subsequent step, the data saved in the optional repository R2 can be transmitted to the measuring entity MI via the data link 106.

Measurement data can be supplied by the measuring entity MI via the connection 105 to a post-processing service PPS for post-processing. The post-processing service PPS saves these measurement data in the repository RI via the connection 108.

The post-processing service PPS also offers the option of replaying and/or purposefully retrieving the saved data for analysis. The replayed and/or purposefully retrieved measurement data are then displayed in particular in the user application BA. The measurement data can either be retrieved and displayed in relation to a specific point in time and/or in relation to a specific period of time, and/or the data can be played back as in a film. Remote access for the user application BA to the measurement data stored in the repository R1 is thus possible via the post-processing service PPS and the measuring entity MI.

It also follows from the description of FIGS. 1 and 2 that remote access for the user application BA to each test environment TU is enabled for the computer resource CR via the measuring entity MI.

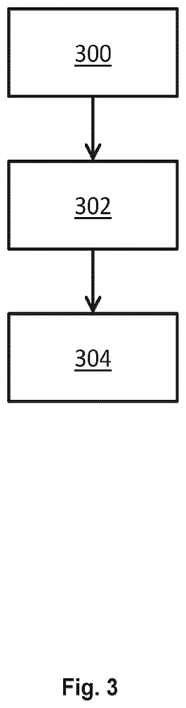

FIG. 3 shows a method in a flowchart.

In method step 300, the test environments TU log themselves in to the experiment manager EM via their respective software agents SWA. In method step 302, the user applications BA log themselves in to the experiment manager EM. The test environments TU and user application BA can also log in to the experiment manager in the reverse order.

In step 304, control data are then transmitted via the connection 101 from the user application BA to the measuring entity MI and transmitted via at least one of the connections 106, 104 to at least one of the test environments TU.

Using the control data, the test environment TU carries out corresponding tests/simulations/measurements on the system under test and transmits the resultant measurement data via the connection 106, 104 to the measuring entity MI. The measurement data relate to the measurement and/or simulation and/or test that has/have been carried out. In particular, the measurement data can comprise measured values acquired from the system under test.

The measuring entity MI processes the measurement data, adapts them to the user application BA, and transmits the correspondingly processed measurement data as display data to the user application BA via the connection 101.

Remote access by one or more user applications BA to one or more test environments TU is thus enabled.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

AW User
AS-1 First login interface
AS-2 Second login interface
BRW Browser
BA User application
TU Test environment
CR Computer resource
EM Experiment manager
KS Monitoring interface
MS Measuring interface
DB Database
MI Measuring entity
PPS Post-processing service
HIL Hardware-in-the-loop simulator
SIL Software-in-the-loop simulator
SWA Software agent
R1, R2 Repository
100 Connection with data exchange: login, display configuration data
101 Connection with data exchange: display data, control data
102 Connection with data exchange: information about logins, control data, configuration data, display configuration data
103 Connection with data exchange: login, configuration data
104 Connection with data exchange: control data, measurement data
105 Connection with data exchange: measurement data
106 Connection with data exchange: control data, measurement data
107 Connection with data exchange: login, configuration data
108 Connection with data exchange: measurement data
300-304 Method steps

1. A device for remotely accessing at least one test environment via at least one user application, wherein the device provides a computer resource available via a communication network, wherein the computer resource comprises an experiment manager and at least one measuring entity, wherein the device comprises:
at least one processor; and
a memory having processor-executable instructions stored thereon;
wherein the at least one processor is configured to execute the processor-executable instructions to facilitate performance of the following by the device:
making, by the experiment manager, a first login interface available to the at least one user application for logging in via the communication network; and
making, by the experiment manager, a second login interface available to the at least one test environment for logging in, wherein the second login interface provides a login via a software agent;
wherein the at least one measuring entity has a monitoring interface for the at least one user application and a measuring interface for the at least one test environment:
wherein the at least one processor is further configured to execute the processor-executable instructions to facilitate performance of the following by the device:
transmitting display data to the at least one user application via the monitoring interface;
receiving control data for the at least one test environment from the at least one user application;
transmitting the control data to the at least one test environment via the measuring interface; and
receiving measurement data for generating the display data from the at least one test environment;
wherein remote access to the at least one test environment is enabled for the at least one user application.

2. The device according to claim 1, wherein, in connection with logging into the at least one test environment, the experiment manager is configured to receive information about the at least one test environment as configuration data.

3. The device according to claim 2, wherein the at least one measuring entity is configured to process the measurement data for generating the display data on the basis of display configuration data.

4. The device according to claim 2, wherein the at least one measuring entity is configured to process the control data on the basis of the configuration data prior to transmission to the at least one test environment.

5. The device according to claim 1, wherein the computer resource has a database that is provided for storing information about logins, control data, measurement data, configuration data, and/or display configuration data.

6. The device according to claim 1, wherein the computer resource has a post-processing service configured to record, manage, and provide access to the measurement data.

7. The device according to claim 6, wherein the database and/or a further repository is provided for storing the measurement data.

8. A method for remotely accessing at least one test environment via at least one user application, wherein a computer resource that is available via a communication network and has an experiment manager and at least one measuring entity is used, wherein the method includes:
logging in the least one user application to the experiment manager; and
logging in the least one test environment to the experiment manager, wherein the at least one test environment uses a software agent for logging in;
wherein the at least one measuring entity has a monitoring interface (KS) for the at least one user application and a measuring interface (MS) for the at least one test environment,
wherein the method further comprises:
transmitting, by the at least one measuring entity, display data to the at least one user application;
receiving, by the at least one measuring entity, control data for the at least one test environment from the at least one user application;
transmitting, by the at least one measuring entity, the control data to the at least one test environment; and
receiving, by the at least one measuring entity, measurement data for generating the display data from the at least one test environment;
wherein remote access to the at least one test environment is enabled for the at least one user application.

9. The method according to claim 8, wherein, in connection with logging in, the at least one test environment transmits information about the at least one test environment to the experiment manager as configuration data.

10. The method according to claim 9, wherein the at least one measuring entity processes the measurement data for generating the display data on the basis of display configuration data.

11. The method according to claim 9, wherein the at least one measuring entity processes the control data on the basis of the configuration data prior to transmission to the at least one test environment.

12. The method according to claim 8, wherein the experiment manager saves information about logins, control data, measurement data, configuration data, and/or display configuration data in a database

13. The method according to claim 8, wherein a post-processing service records, manages, and/or provides access to the measurement data.

14-17. (canceled)

18. A system, comprising:
a device; and
at least one test environment;
wherein the device provides a computer resource available via a communication network, wherein the computer resource comprises an experiment manager and at least one measuring entity;
wherein the device is configured to:
make, via the experiment manager, a first login interface available to at least one user application for logging in via the communication network; and
make, via the experiment manager, a second login interface available to the at least one test environment for logging in, wherein the second login interface provides a login via a software agent:
wherein the at least one measuring entity has a monitoring interface for the at least one user application and a measuring interface for the at least one test environment;
wherein the device is further configured to:
transmit display data to the at least one user application via the monitoring interface;
receive control data for the at least one test environment from the at least one user application;
transmit the control data to the at least one test environment via the measuring interface; and
receive measurement data for generating the display data from the at least one test environment;
wherein remote access to the at least one test environment is enabled for the at least one user application.

19. The system according to claim 18, wherein the at least one test environment is configured to communicate with the device;
wherein the at least one test environment is configured to test a system to be tested and to generate the measurement data, wherein the measurement data is based on the testing of the system to be tested.

20. The system according to claim 18, wherein the at least one test environment has the software agent (SWA), wherein the software agent (SWA) is provided for logging in to the experiment manager.

21. The system according to claim 18, wherein the at least one test environment is configured to communicate with the device via the communication network.
